(19) United States
(12) Patent Application Publication
(10) Pub. No.: US 2010/0145870 A1
(43) Pub. Date: Jun. 10, 2010

(54) T.E.S.S. Teacher Evaluation Systems Software

(75) Inventor: Rodney James LUSTER, Leander, TX (US)

Correspondence Address: RODNEY LUSTER, 1826 HORIZON PARK BLVD, LEANDER, TX, 78641, US

(73) Assignee: RODNEY LUSTER JAMES RODNEY LUSTER, LEANDER, TX (US)

(21) Appl. No.: 12/624,661

(22) Filed: Nov. 24, 2009

Related U.S. Application Data
(60) Provisional application No. 61/200,067, filed on Nov. 24, 2008.

(30) Foreign Application Priority Data
Nov. 24, 2008 (US) 61200067

(51) Int. Cl. G06Q 50/00; G06Q 10/00

(52) U.S. Cl. 705/321; 705/326

(57) ABSTRACT

T.E.S.S. is a Teacher Evaluation Assessment Software which evaluates the teacher/candidate based on a series of pre-designed questions that probe teaching styles, traits, strengths & weaknesses as related to the vocation of teaching. Results determine teaching styles/archetypes (The Discoverer, The Sage, The Counselor and The Motivator), in addition to learning styles associated, methods to assist the client, qualities & characteristics adaptable to the profession, a movie reference that fits learner style, tools for teachers, need to knows and a supervisory portion if requested by administrator for client to assist in supervising to their preferred teaching style. Employers/Clients are provided pdf/word document of results. Used for development of faculty/staff and as a screening tool for schools and universities for teacher candidates.

### BACKGROUND OF INVENTION

Assessing a teacher has not been the primary focus of national entities such as the Department of Education or Accreditation agencies. What have been examined are student outcomes which continue to be a primary focus. To date, research has been done in the area of learner styles and association made or accorded to teachers who teach to those styles. Styles arise from the needs of the learner or should in theory. Some research has also identified specific styles related to teaching styles and inventories related to problem based learning. What research is beginning to uncover is the impact that a quality learning experience has on student outcomes. This has everything to do with the instructor.

T.E.S.S. is a Teacher Evaluation Software which evaluates the teacher/candidate based on pre-designed questions that probe teaching styles, traits, strengths & weaknesses as related to the vocation of teaching. Results determine teaching styles (The Discoverer, The Sage, The Counselor and The Motivator), learning styles associated, methods to assist the client, qualities & characteristics adaptable to the profession, movie reference that fits learner style, tools for teachers, need to knows and a supervisory portion if requested by administrator for client to assist in supervising to their preferred teaching style. Employers/Clients are provided pdf/word document of results. Used for development and as a screening tool. First (1st) generation software targets 1st-12th grade as well as university teachers/candidates, 2nd generation software-to be the next layer of development for T.E.S.S. will assess specific to each level of education for instructors teaching at various levels. Third generation will assess results relative to generation in which teacher belong as well as break out to all forms of presentation and lecture style.

As an evaluation subscription service, T.E.S.S. software will become a tool for hiring teachers or teacher candidates, training student teachers and will be used to evaluate and assess/profile teaching styles, strengths, and qualities or traits deemed applicable to the profession and standards of teaching and ways to improve or enhance client's style. T.E.S.S. is a strengths based, development tool. The software can be used for developmental purposes. The information will also be available to hiring staff and administrators as a tool to develop a good placement and growth-pathing for individuals. To date, there are no other known software assessment instruments for teachers to assess teaching strengths.

### SUMMARY OF THE INVENTION

T.E.S.S. is a strengths-based assessment instrument. This software was designed to assist teachers in enhancing their self-concept. If you do not know what kind of teacher you are, T.E.S.S. will assist in showing the client their personal style or preference in results gathered from the instrument. Research into the idea of teaching styles has a long history and many authors, as well as several disciplines, from psychology to education. For years there have been categories assigned to learning styles from the likes of educational theorists such as Dr. David Kolb and his four preferred approaches to Peter Honey and Alan Mumford's four adopted learning style stages. The scope of attempting to become a better teacher means that we must learn more about ourselves, our learning preferences as extensions of our teaching styles and what those particular teaching preferences are and how we can best capitalize on them in the classroom.

Author, educator, researcher and President of Way2Teach Inc., Dr. Rodney Luster, has researched for over 13 years of experience as a teacher, administrator, and Peer Reviewer for the Higher Learning Commission, the elements and components found in the “best of the best” teachers and what the future of accrediting bodies will be looking for in institutions who are preparing and developing teachers for the future. Through extensive research there are at least 20 essential and identifiable qualities that are consistent in top teachers but the qualities are also evidenced in the research used to compile and create the first software known as T.E.S.S. used to identify teacher strengths. The software is based as well on the ideas posited by positive psychology as a discipline.

The software will not tell you your deficits as some other instruments reveal. Instead, Positive Psychology seeks to study the strengths that assist in nurturing individuals to thrive in their environment. The instrument will reveal one of four character domains regarding teaching preferences that, the teacher-client, appears to prefer in their final results analysis. T.E.S.S. is a software which evaluates the teacher/candidate based on a series of pre-designed questions that probe teaching styles, traits, strengths & weaknesses as related to the vocation of teaching. Results determine teaching styles. (The Discoverer, The Sage, The Counselor and The Motivator). TESS will also cross reference known learning styles associated and match them to the client as well as providing methods (teaching strategies, to assist the client, in addition to providing qualities & characteristics adaptable to the profession, a unique movie reference that fits the learner style, tools for teachers, “need to knows” and a supervisory portion if requested by administrator for client to assist in supervising to their preferred teaching style.

### BRIEF DESCRIPTION OF THE SEVERAL VIEWS OF THE DRAWING

The drawing provided herein displays a workflow diagram of T.E.S.S. which displays user input received based on conditions resulting from client input initially such as demographic information; moving to the actual assessment instrument where client's responses to survey instrument result in carefully constructed outcomes based on predetermined variables that are then formatted and assigned to the client. The processed final product (report) is then delivered via pdf to client.

FIG. 1—Describes the T.E.S.S software that is a server based (location), storage and computing system.

FIG. 2 addresses the initial first stage of client login to the subscription based software where the client enters specific demographic information into the system.

FIG. 3 is the next system decision that allows the client to receive a uniquely generated pin or ID thus allowing them to gain access to the survey assessment instrument.

FIG. 4 describes the process that the system moves to where a unique pin is then sent to the client's e-mail or displayed to the client.

FIG. 5 describes the client's ability to log back into the survey instrument and begin accessing the survey.

FIG. 6 describes the first section of the survey where more demographic information is collected from the client.

FIG. 7 describes the client's entry into the systems survey where a series of questions are populated and the client begins answering them.

FIG. 8 is the next system step where, after the survey is completed, the system calculates answers and renders a complex analysis document sent to the clients e-mail address in pdf format (other formats optional).

FIG. 9 is the owners' report that is accessible to client's administrator as well (supervisor) who can collect the report on client via link generated.

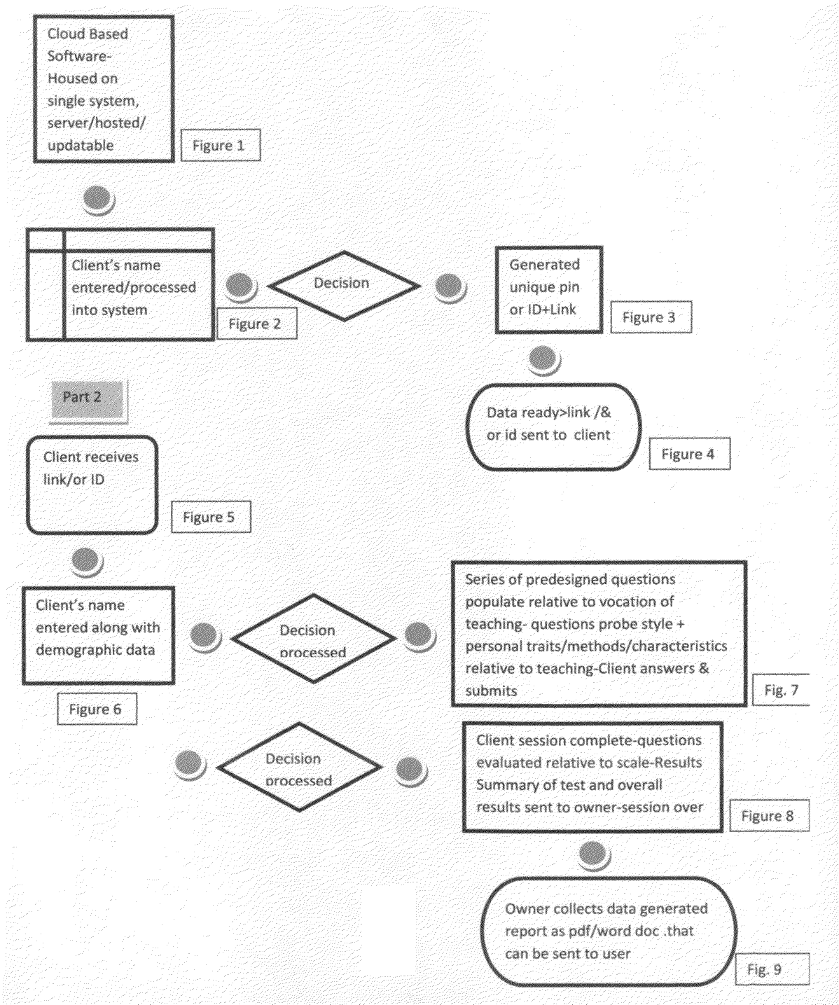

### DETAILED DESCRIPTION

### Components

The evaluation software will be simple in design, general in structure and purpose for the first phase of existence targeting or encompassing all instructional levels (1st through College level).

### Design

The strengths based assessment software will have a software logo and branding design for its product significance that will be the exclusive property of the owner of the software, Rodney Luster, President of Way2Teach Inc. T.E.S.S. will be the name of the software.

### Set Up

3 iterations of the software planned

### T.E.S.S. Process

1st—When the client (school district, college or university department or human resources) purchases the subscription, they have access to T.E.S.S. (which will remain a cloud based service housed on the owners server-Rodney Luster/Way2Teach Inc) where they will be prompted to a set up screen wherein they can enter their name or affiliate institution—school name, department (if applicable) address, phone, fax, web, and email address and various demographic data collected by the system. This set up screen will interface with other screens where for instance they will be guided to take the strengths based assessment as well as a screen and process for collecting pdf report results—these various screens access all reports and will show those pieces of information on all items that represent the client in email or letters and so on to the client. The client will receive a pdf report that they can download that provides results of their preferred teaching style, methods, tools that can be used in relation to, and a supervisory/administrative piece for those who seek to provide their results to their managers.

Client must purchase a subscription to use and access T.E.S.S. on a per diem basis. T.E.S.S. would then be housed on a owner server or hosting source.

### Content

The service based software will house a database that will have static information that causes the system to perform the evaluation. The software will also storage the client information (school district, college or university department or human resources.) In later iterations the software will also track the employees or perspective employees who have taken the test and the results. For the first iteration T.E.S.S. will provide detailed results on the clients teaching style, learner style, and tools to assist them to enhance their teaching styles. All static information will remain hard coded. Clients can use the “cloud based” system on a per diem basis.

### Forms

T.E.S.S. will be housed on owner site (Way2Teach.com) on an Internet page where the subscription information and buttons will allow access to client after payment is made for service. T.E.S.S. will open in easy to use interface with forms that will appear on the screen with easy to use click option buttons. The following are the basic Forms (but are not limited to only these forms) that the user will encounter Login—When the software/or link opens for the first time the user will have received their login name and password and will login or will receive it upon entering the subscription service. Set Up and Welcome Screen—The client will enter set up information and will click enter to continue. Client will then enter the potential person's name who wishes to take the test. A link will be generated and sent to the client or client may be given access upon payment at moment of subscription (to be determined). Upon receiving the link, the client can take the assessment.

### Software Structure

Main Switchboard—Housed on internet
Evaluation Link—will open a sub-form

### Start an Evaluation

### Geographic Information

### Test

Administrative Link—Permissions only—To be decided

### Review Evaluations

### Generate Reports

### Letter Writer

### Employee Main

### Reports

The Report switchboard will provide basic information in the first phase of the software and can grow to include many analytical reports. All reports can be exported to word, pdf, and sent via email or downloaded at that point by client.

### Employee Evaluation Test—For Employee

### Employee Evaluation Test—For Administrator

Hard Coded Reports explaining the test, how it works, and how it is interpreted

### Summary of Test and Overall Results

Letter Writer Reports from the preset templates

### Users

The software will be designed to work on one work station for the inventor—housed as a cloud based service via the internet on a website (currently Way2Teach.com). No installation necessary by client.

The owner of the software, Rodney Luster may choose to designate a web hosting service to house T.E.S.S. for subscription only clients or to offer a one-to-many application wherein the school opts to pay for each department to have a way to access T.E.S.S. All results are housed on owner's server/database.

### Platform

The software will be housed on owner's local website as a cloud based service for all subscribers.

Software Description: Evaluation Software much like a personality assessment instrument designed with questions that are evaluated relative to a scale and results that determine teaching styles, qualities and characteristics adaptable to the profession this instrument is targeted for, namely teaching.

Process—a person will answer a series of questions, click submit and results will be populated with detailed analysis, graphs, analysis of potential teaching style/s, associated characteristics and traits and assessed qualities associated with the teacher as a person. Ultimately, this will be marketed to educational providers but may open to other industries.

1. (canceled)

2. (canceled)

3. Results determine teaching styles (The Discoverer, The Sage, The Counselor and The Motivator), learning styles associated, methods to assist the client, qualities & characteristics adaptable to the profession, movie reference that fits learner style, tools for teachers, “need to knows” and a supervisory portion if requested by administrator for client to assist in supervising to their preferred teaching style.

4. (canceled)

5. (canceled)

6. (canceled)

7. Evaluation subscription service based on T.E.S.S. software will become a tool for hiring teachers or teacher candidates, training student teachers and will be used to evaluate and assess/profile teaching styles, strengths, and qualities or traits deemed applicable to the profession and standards of teaching and ways to improve or enhance client's style.

8. (canceled)

9. (canceled)

10. (canceled)

11. (canceled)

12. (canceled)

13. Assessment instrument pdf delivers the following parts: TESS Summary, The 4 Domains of Teaching—Four Variations of Experiencing teaching, graphed results, teacher archetype, specific qualities associated with the teacher, Learning theory associated, Supervisory section.
